(19) United States
(12) Patent Application Publication
(10) Pub. No.: US 2015/0283954 A1
(43) Pub. Date: Oct. 8, 2015

(54) VEHICLE SEAT COVER HAVING A CATCHING ARRANGEMENT

(71) Applicant: WHO-RAE PTY LTD, South Melbourne (AU)

(72) Inventors: Ray Pawsey, Southbank (AU); Nan Shao, Southbank (AU)

(73) Assignee: WHO-RAE PTY LTD, South Melbourne (AU)

(21) Appl. No.: 14/246,534

(22) Filed: Apr. 7, 2014

(51) Int. Cl. B60R 11/00; B60N 2/58

(52) U.S. Cl. CPC B60R 11/00; B60N 2/58

(57) ABSTRACT

A vehicle seat cover (1) for a vehicle seat (3), the vehicle seat cover (1) covering at least part of the vehicle seat (3) when installed on the vehicle seat (3), and including a catching arrangement (15) secured to the vehicle seat cover (1) and locatable along at least one side of the vehicle seat (3) when the vehicle seat cover (1) is installed on the vehicle seat (3), the catching arrangement (15) providing an accommodating volume (17) having an upper opening (19) at said side of the vehicle seat (3).

### FIELD OF THE INVENTION

The present invention is generally directed to vehicle accessories, and in particular, to accessory covers for vehicle seats. While the present invention will be described in relation to its use on automobile seats, it is to be appreciated that the present invention is not limited to this application, and that alternative applications are also envisaged.

### BACKGROUND OF THE INVENTION

Modern automobiles are almost universally designed to have a pair of front seats separated by a central console. The seat , the adjacent central console, and the adjacent automotive door panel are often very closely positioned together due to space limitations within the interior of the vehicle. This results in the gap provided between the seat and the central console, and between the seat and the door panel being very narrow. This can make it very difficult or impossible to retrieve objects such as coins, lipsticks, eyeliners and mobile phones that may have accidentally or inadvertently fallen into the gap. It would therefore be preferable to be able to prevent objects from falling into that gap in the first place thereby avoiding the need to retrieve objects from that gap.

### SUMMARY OF THE INVENTION

It is an object of the present invention to provide an arrangement that prevents or limits objects falling into at least one of the gaps immediately adjacent a vehicle seat cushion.

With this in mind, the present invention provides a vehicle seat cover for a vehicle seat, the vehicle seat cover covering at least part of the vehicle seat when installed on the vehicle seat, and including a catching arrangement secured to the vehicle seat cover and locatable along at least one side of the vehicle seat when the vehicle seat cover is installed on the vehicle seat, the catching arrangement providing an accommodating volume having an upper opening at said side of the vehicle seat.

According to a preferred embodiment of the invention, the catching arrangement may be formed from a web of material secured to the vehicle seat cover. The web may be secured along a part of a periphery of the web to the seat cover. The web may further have an upper edge which may be positioned to form the upper opening of the catching arrangement. The web therefore provides the accommodating volume in the form of a pocket and the upper opening of the catching arrangement.

The catching arrangement may preferably include a stiffening structure located at or adjacent the upper edge to position the upper edge of the web to form the pocket having the upper opening. The stiffening structure may be in the form of an elongate bendable element secured at or adjacent the upper edge of the upper part of the web. This bendable element may for example be tubular in cross-section or may be in the form of a strip. Other cross-sections for the bendable element are also envisaged. The bendable element may be formed to the required shape to allow the upper edge of the web to be positioned away from the vehicle seat after installation of the seat cover to provide the upper opening of the catching arrangement. At least one end of the bendable element may be supported by the vehicle seat cover to hold the bendable element in position relative to the rest of the seat cover.

It is alternatively envisaged that a spacer element be located between the web and the vehicle seat to space at least the upper part of web away from the seat to thereby provide the accommodating volume and the upper opening. The spacer element may, for example, be in the form of a rounded wedge that can be slipped between the seat cover and the flexible web. The spacer element may, be formed from resilient materials such as foam or gel material. It is, however, also envisaged that the spacer element be formed from rigid material.

The seat includes a seat base, and a back rest, and the seat cover may therefore include a seat portion for covering at least part of the seat base, and a back rest portion for covering at least part of the back rest. The catching arrangement may be preferably secured to at least the seat portion of the vehicle seat cover. Alternatively, the catching arrangement may be secured to and extend between the seat portion and the back rest portion of the vehicle seat cover. Separate catching arrangements may also be secured to the seat cover so that catching arrangements can be located along both sides of the vehicle seat. Separate webs providing the catching arrangement may therefore be provided on each side of the seat cover when installed on the vehicle seat. It is also envisaged that a web extends from one side of the vehicle seat, and behind the vehicle seat to the other side thereof. This enables the web to also form a rear pocket for the vehicle seat. It is also envisaged that the flexible web extends completely around the seat cushion, in which case the flexible web can also provide a front pocket for the vehicle seat in addition to the rear pocket.

The web may be formed using stretchable plain or net fabric material. Such stretchable fabric materials can typical be made from polyester and lycra (Registered Trademark). It is however alternatively envisaged that the web be formed of a mouldable material to allow the moulding of the web into the required pocket shape for the catching arrangement without the need for any other bendable or spacer element. The web may for example be formed from a silicon plastic mesh that is mouldable. It is however also envisaged that the web be formed from rigid material such as polypropylene.

The catching arrangement may be secured to the vehicle seat cover at the time of manufacture of the seat cover using stitching or adhesive. It is however also envisaged that the catching arrangement be subsequently secured to the seat cover after installation. For example, Velcro (Registered Trademark) could be used to secure the catching arrangement to the seat cover after installation of the seat cover on the vehicle seat.

A belt buckle clasp is typically located in the gap adjacent the vehicle seat. At least one aperture may therefore be provided through the catching arrangement to accommodate the seat belt clasp which can be passed through the provided aperture.

The location of the catching arrangement at the side of the vehicle seat will result in the catching arrangement being positioned over the gap between the vehicle seat and the central console or door panel in the case of an automobile. The catching arrangement therefore acts to prevent or limit objects falling into the gap, by providing a pocket having an upper opening to catch objects falling towards the gap. The catching arrangement therefore allows for easy retrieval of the objects which may be accommodated within the volume provided by the catching arrangement

### BRIEF DESCRIPTION OF THE DRAWINGS

It will be convenient to further describe the invention with reference to the accompanying drawings which illustrate preferred embodiments of the present invention. Other embodiments are envisaged, and consequently, the particularity of the accompanying drawings is not to be understood as superseding the generality of the preceding description of the invention.

In the drawings:

FIG. 1 is a front view of a vehicle seat upon which has ben installed a vehicle seat cover according to the present invention;

FIG. 2 is a top view of the car seat cover of the FIG. 1;

FIG. 3 is a side view of the car seat cover of FIG. 1;

FIG. 4 is a detailed view of the catching arrangement of the car seat cover of FIG. 1; and

FIG. 5 is a detailed view of an alternative embodiment of the catching arrangement of the car seat cover according to the present invention.

### DETAILED DESCRIPTION OF THE PREFERRED EMBODIMENTS

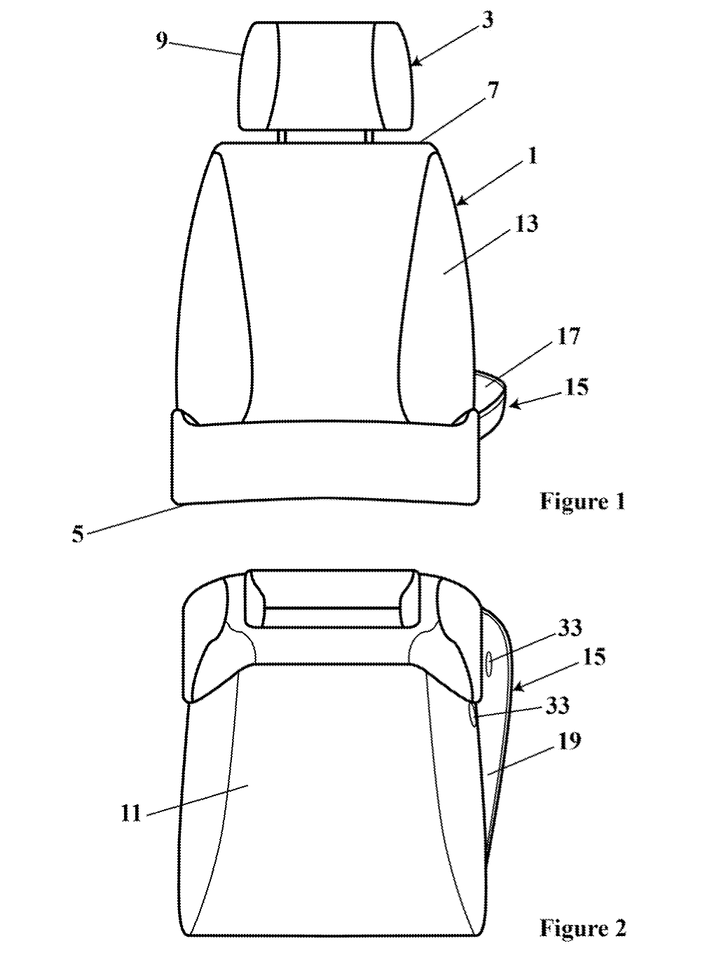

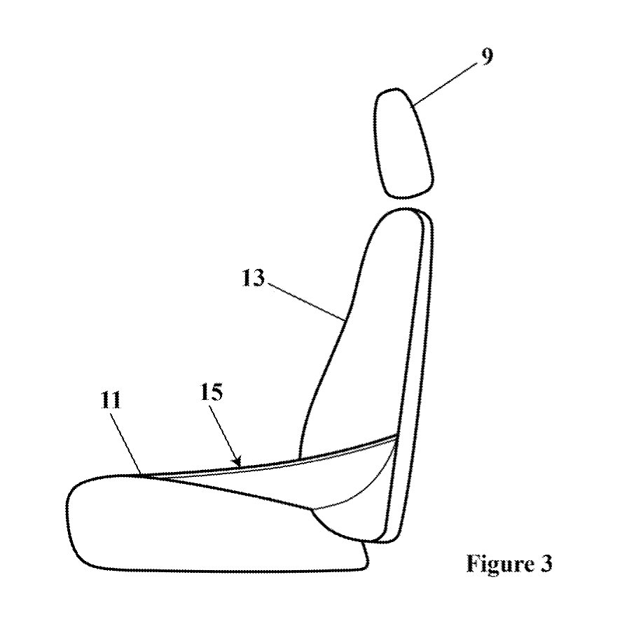

Referring initially to FIGS. 1 to 3, the car seat cover 1 according to the present invention is designed to cover a vehicle seat 3. In the case of a automobile, the vehicle seat 3 typically includes a seat base 5, a backrest 7, and a head rest 9. The seat cover 1 according to the present invention includes a seat cover portion 11 for covering at least a part of the seat base 5, and a back rest portion 13 for covering at least part of the back rest 7.

The seat cover 1 according to the present invention includes a catching arrangement 15 extending between and secured to the seat portion 11 and the back rest portion 13 of the seat cover 1. The catching arrangement 15 is positioned to form a pocket having an accommodating volume 17 and an upper opening 19.

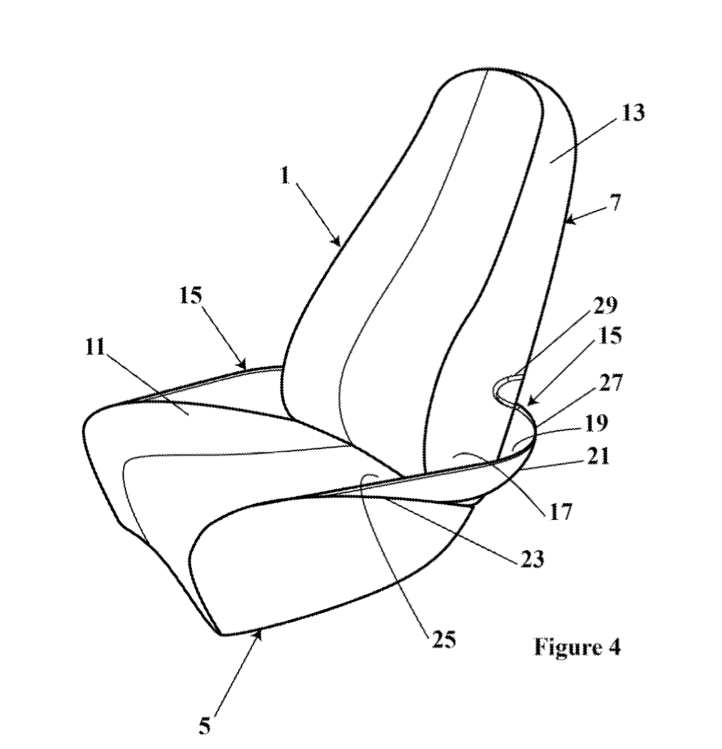

Referring now to FIG. 4, there is shown in more detail a first embodiment of the catching arrangement 15 which is shown in the form of a web of material 21 secured along a peripheral edge 23 thereof to the seat portion 11 and the back rest portion 13 of the seat cover 1. The catching arrangement 15 includes a stiffening structure 27 provided along an upper edge 25 of the web 21. The stiffening structure 27 can be bent to position the upper edge 25 of the web 21 away from the seat cushion 5 and back rest 7 of the vehicle seat to form the upper opening 19. The stiffening structure 27 may be in the form of an elongate bendable element such as a wire, tube or flexible strip. An end 29 of the stiffening structure 27 can be formed into an S-shape which can be stitched into a pocket (not shown) in the back rest portion 13 of the seat cover 1. This arrangement helps to retain the stiffening structure 27 in a position which allows the catching arrangement 15 to provide the accommodating volume 17 and upper opening 19 along the side of the seat where the catching arrangement 15 is positioned.

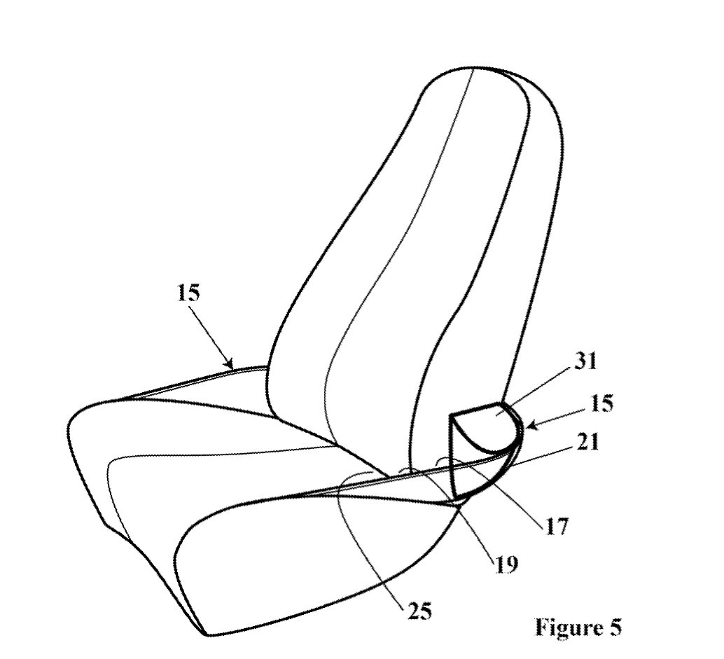

FIG. 5 shows an alternative embodiment of a catching arrangement 15 according to the present invention. This embodiment is similar to the previously described embodiment and the same reference numerals are used for corresponding features. In particular, the catching arrangement 15 is also in the form of a web of material 21 secured to the car seat portion 11 and back rest portion 13 of the car seat cover 1. The web 21 also includes an upper edge 25. A spacer element 31 is however used to displace the upper edge 25 of the web 21 away from the seat portion 11 and backrest portion 13 of the seat cover 1. This catching arrangement 15 therefore also provides the accommodating volume 17 an upper opening 19 according to the present invention.

While the catching arrangement 15 is described as being located on one side of the car seat, another catching arrangement 15 can also be provided on the other side of the seat cover as shown in FIGS. 4 and 5. Furthermore, the catching arrangement 15 may alternatively be formed from rigid material or mouldable material. For example, the catching arrangement may be formed from flexible mouldable material such as polypropylene. This mouldable catching arrangement may be subsequently secured to the car seat cover using attachment means such as adhesive or Velcro. Alternatively, the catching arrangement 15 may be formed of a mouldable material such as silicon plastic mesh which allows the catching arrangement to be moulded to the correct shape.

The seat belt clasp is also typically located adjacent the side of the seat base 5. One or more apertures 33 (see FIG. 2) can therefore be provided through the catching arrangement 15 to provide clearance for the seat belt clasp to extend through the aperture 33 in the catching arrangement 15.

The position of the catching arrangement along one or both sides of the vehicle seat will help to ensure that any objects that inadvertently falling towards the gap provided between the car seat and the adjacent centre console or door panel will instead fall within the accommodating volume of the catching arrangement. This then allows for easy retrieval of these falling objects making it unnecessary to try to retrieve objects that have fallen in the previously mentioned gaps.

Modifications and variations as would be deemed obvious to the person skilled in the art are included within the ambit of the present invention as claimed in the independent claims.

What is claimed is:

1. A vehicle seat cover for a vehicle seat, the vehicle seat cover covering at least part of the vehicle seat when installed on the vehicle seat, and including a catching arrangement secured to the vehicle seat cover and locatable along at least one side of the vehicle seat when the vehicle seat cover is installed on the vehicle seat, the catching arrangement providing an accommodating volume having an upper opening at said side of the vehicle seat.

2. A vehicle seat cover according to claim 1, wherein the catching arrangement includes a web of material secured to the vehicle seat cover, the web being secured along a part of a periphery of the web to the seat cover, the web having an upper edge that can be positioned to thereby provide the accommodating volume and the upper opening thereof.

3. A vehicle seat cover according to claim 2 wherein the catching arrangement further includes a stiffening structure located at or adjacent the upper edge of the web for positioning the upper edge of the web.

4. A vehicle seat cover according to claim 3, wherein the stiffening structure is in the form of an elongate bendable element.

5. A vehicle seat cover according to claim 2, further including a spacer element locatable between the seat cover and the web for positioning the upper edge of the web.

6. A vehicle seat cover according to claim 1, wherein the seat has a seat base and a backrest, and the seat cover has a seat portion for covering at least a part of the seat base, a backrest portion for covering at least part of the backrest, the catching arrangement extending between the seat portion and backrest portion of the car seat cover.

7. A vehicle seat cover according to claim 1, wherein the catching arrangement is secured to the car seat cover following installation of the car seat cover on the vehicle seat.

8. A vehicle seat cover according to claim 1, wherein at least one aperture is provided through the catching arrangement to provide clearance for a seat belt buckle to pass therethrough.
